(19) United States
(12) Patent Application Publication
(10) Pub. No.: US 2005/0164785 A1
(43) Pub. Date: Jul. 28, 2005

(54) Gaming device having independently selected concurrent audio

(75) Inventor: Michael P. Connelly, Elmwood Park, IL (US)

Correspondence Address: SCHWEGMAN, LUNDBERG, WOESSNER & KLUTH, P.A., P.O. BOX 2938, MINNEAPOLIS, MN, 55402-0938, US

(73) Assignee: WMS Gaming Inc.

(21) Appl. No.: 10/764,739

(22) Filed: Jan. 26, 2004

(51) Int. Cl. A63F 13/00

(52) U.S. Cl. 463/35

(57) ABSTRACT

A computerized gaming system has an audio module that is operable to play an audio track comprising a plurality of audio element tracks that are played at the same time to create the played audio track. The audio element tracks are selected by subgroup, at random, by ordered list, or otherwise selected to produce different combinations of the available audio element tracks. The gaming system further comprises a gaming module, which includes a processor and gaming code which is operable when executed on the processor to conduct a game of chance on which monetary value can be wagered.

### FIELD OF THE INVENTION

The invention relates generally to gaming systems, and more specifically to gaming systems having independently randomized audio tracks.

### BACKGROUND OF THE INVENTION

A wide variety of gaming devices are now available to gamers and to casino operators in computerized form, from slot machines to games that are traditionally played live such as poker and blackjack. These computerized games provide many benefits to the game owner and to the gambler, including greater reliability than can be achieved with a mechanical game or human dealer, more variety and animation in presentation of a game, and a lower overall cost of production and management.

Computerized video game systems must be designed with many of the same concerns as their mechanical and table game ancestors—they must be fair, they must provide sufficient feedback to the gamer to make the game fun to play, and they must meet a variety of gaming regulations to ensure that both the machine owner and gamer are honest and fairly treated in implementing the game. Further, they must provide a gaming experience that is at least as attractive as the older mechanical gaming machine experience to the gamer, to ensure success in a competitive gaming market.

Many computer elements have been employed in gaming systems, from computerized animation to playing prerecorded sounds through a gaming system's speakers. These are carefully designed, along with the general theme and other elements of a gaming system, to attract the attention of gamers and to provide a memorable gaming experience. But, because computerized gaming systems are produced in a very competitive environment, the amount of storage space incorporated into each game is necessarily limited. This results in relatively little music being available in the typical gaming system, which can begin to sound repetitive after gaming for some time. This is undesirable, because repetition detracts from the gamer's enjoyment of the presented game.

It is therefore desired to employ a gaming system in which the user is not presented with audio programming having repetition, and that further conserves storage space within the gaming machine.

### SUMMARY OF THE INVENTION

The present invention provides in one embodiment a computerized gaming system having an audio module that is operable to play an audio track comprising a plurality of audio element tracks that are played at the same time to create the played audio track. In various further embodiments, the audio element tracks are selected by subgroup, at random, by ordered list, or otherwise selected to produce different combinations of the available audio element tracks. The gaming system further comprises a gaming module, which includes a processor and gaming code which is operable when executed on the processor to conduct a game of chance on which monetary value can be wagered.

### BREIF DESCRIPTION OF THE FIGURES

FIG. 1 shows a computerized gaming system having an audio module consistent with an embodiment of the present invention.

FIG. 2 shows a plurality of audio element tracks consistent with an embodiment of the present invention.

FIG. 3 is a flowchart showing a method of generating an audio track in a computerized gaming system, consistent with an embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in one embodiment a computerized gaming system having an audio module that is operable to play an audio track comprising a plurality of audio element tracks that are played at the same time to create the played audio track. In various further embodiments, the audio element tracks are selected by subgroup, at random, by ordered list, or otherwise selected to produce different combinations of the available audio element tracks. More detailed examples of the present invention are presented here to further illustrate how the present invention as claimed may be practiced in different embodiments.

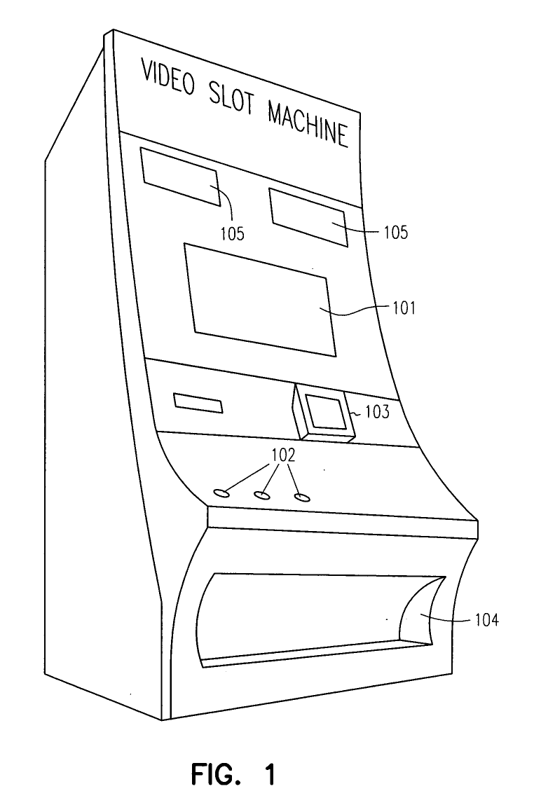

FIG. 1 illustrates a computerized gaming system having an audio module, consistent with an embodiment of the present invention. The computerized gaming system shown generally at 100 is a video gaming system, which displays information for at least one game of chance on video display 101. The game of chance is played and controlled with various buttons 102, and value is wagered on the games such as with tokens, coins, bills, or cards that hold value. The wagered value is conveyed to the machine through a changer 103, and winnings are returned via the returned value card or through the coin tray 104.

Modern computerized gaming systems employ a variety of video and animation effects on the video screen 101 to attract gamers and to enhance the gaming experience. This experience is further enhanced by presentation of audio via speakers 105, including music and various sound effects presented both to attract attention and to enhance the gaming experience. These audio tracks are stored in the gaming system, and are played back via the speakers, and are usually selected depending on the present state or activity of the gaming system. For example, one type of audio track may play when the system is not currently being used but is trying to attract customers, while another type of audio track may be used while a game is actually in process.

But, due to the expense of creating audio tracks, the cost of storage space, and the resulting limited amount of storage space available in a typical gaming machine, the number and variety of audio tracks present in a computerized gaming machine is typically limited. The present invention therefore seeks in various embodiments to employ audio element tracks that can be combined in various ways for concurrent playback, thereby creating a variety of audio tracks that are played back through speakers 105. In this way, a variety of unique audio tracks can be assembled from the combined audio element tracks, where each audio track comprises some combination of audio element tracks being played back at the same time.

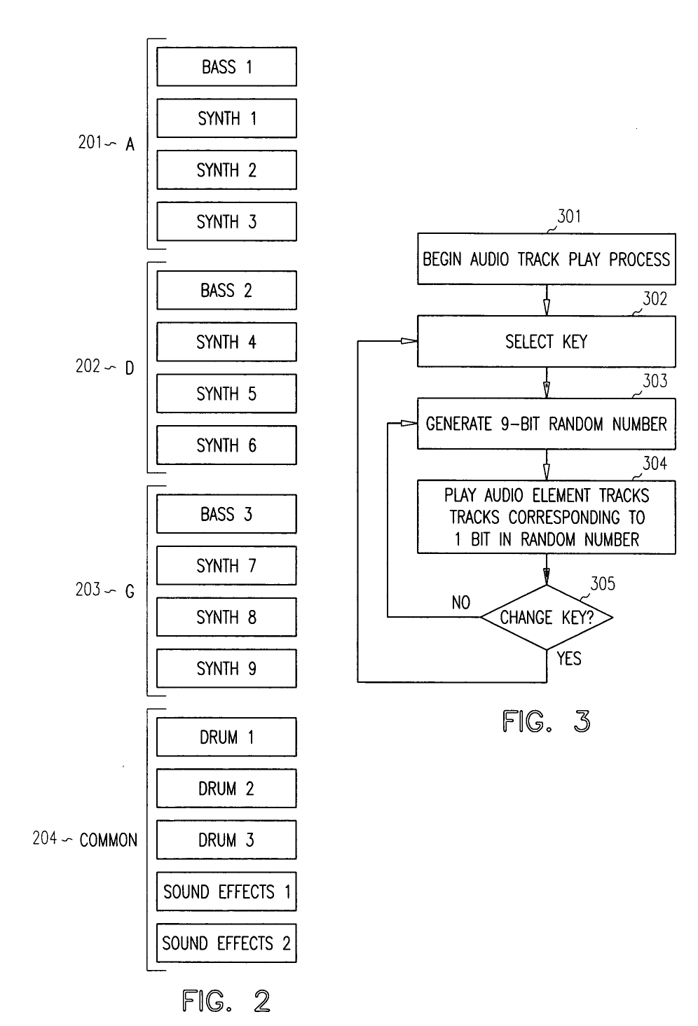

FIG. 2 illustrates a collection of audio element tracks, consistent with an embodiment of the present invention. The audio element tracks are organized in subgroups, including subgroups 201, 202, and 203 which contains audio element tracks in the keys of A, D, and G, respectively, and common subgroup 204 which is not key-dependent. To play an audio track in the key of A, at least one of the audio element tracks from subgroup 201 is played, with or without at least one of the audio elements from the common subgroup 204. For example, one of drum tracks 1, 2, or 3 from common subgroup 204 may be played at the same time as bass track 1 and one of synth tracks 1, 2, or 3 to create a track for playback through the gaming system's audio speakers 105. Further, one or both of sound effects tracks 1 and 2 can also be played back from common subgroup 204, to provide sound effects that further enhance the played audio track.

When the key of the played audio track changes, such as when a different phase of the game is entered, track elements from a new subgroup corresponding to the new key are selected and played back. The specific tracks selected, and the order in which different tracks are combined, will serve to add variety to the played audio track. Combining different drum tracks with different special effects tracks and different synthesizer tracks as in the example of FIG. 2 will ensure that the same combination of tracks is not repeated over and over again, resulting in a more interesting audio presentation for the gamer.

The exact order of track selection, and inclusion or exclusion of specific tracks, is determined in different ways in various embodiments of the invention. In some embodiments, a random number generator is used to select which tracks to play, while in other embodiments the tracks to be combined for playback are read off a preordered list. A variety of other methods can be employed to ensure that the played audio tracks do not simply repeat but vary with time, all of which are within the scope of the present invention. Some further embodiments of the invention will employ such methods to vary parameters other than the specific audio element tracks being played back, such as the element track's volume, panning, reverberation, equalization, distortion, compression, flange, and phase effects.

The various audio element tracks shown in FIG. 2 are also in some embodiments of the invention different in length, such that the tracks overlap in different ways when played back together. For example, an element track that is four measures in length that is played multiple times along with a track that is three measures in length will play with a different measure synchronization between tracks the first four times the four-measure track is repeated. Also, because the element tracks contain different types of content and space is typically at a premium, the recording format of the various element tracks can vary from track to track. As an example, the bass tracks of FIG. 2 likely contain mainly low frequency content that is not particularly directional and so may be recorded in mono at 11.025 kHz sampling rate, while sound effects and synthesizer tracks containing more detailed content at higher frequencies are recorded in stereo at 22.05 kHz. This enables the bass tracks to consume one-quarter the storage of a sound effects or synthesizer track of the same length, yielding a substantial savings in consumed storage space. In further embodiments, various compression schemes, such as MPEG, AAU, or other audio compression methods may be applied to the audio element tracks, including application of lossy compression methods to the extent that the resolution loss due to compression can be tolerated for each specific audio element track.

FIG. 3 illustrates one simple method of practicing the present invention, using the audio element tracks of FIG. 2. The audio track play process is initiated at 301, indicating that an audio track is to be created and played through speakers 105. At 302, a musical key is selected from among the keys A, D, and G, as shown in conjunction with subgroups 201, 202, and 203 of FIG. 2. For the present example, assume selection of the key of D. Next, a 9-bit random number is created at 303, where each bit of the 9-bit number corresponds to one track that is eligible to be played in the key of D. This includes bass track 2 and synth tracks 4, 5, and 6 from the key of D subgroup 202, and drum tracks 1, 2, and 3, and sound effects tracks 1 and 2 from the common subgroup 204. A randomly generated one bit will indicate that the corresponding track will be played, while a randomly generated zero bit will indicate that the corresponding track will not be played. Applying a random number 101101011 to the series of eligible audio element tracks listed above and shown in FIG. 2 would therefore result in playing bass track 2, synth tracks 5 and 6, drum track 2, and sound effects tracks 1 and 2 at 304 in the flowchart. The tracks synth 4 and drum tracks 1 and 3 are not played, but may be played the next time through.

Preferably before the selected tracks have completed playing, it is determined whether a key change is needed at 305. This may be determined by changed game conditions, by time, randomly, or by any other method. By doing so, a new key can be selected at 302 if necessary, a new random number can be generated at 303, and corresponding new audio elements can be ready for play at 304 as soon as the previously playing tracks are completed.

These examples show some of the many ways in which a computerized gaming system can combine selected audio elements to create a played audio track, consistent with the present invention. The examples here seek to vary the audio element tracks selected for playback so that the gamer's experience is enhanced by varying combinations of audio element tracks instead of simple repetition of the same single audio track.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A computerized gaming system, comprising:
a gaming module, comprising a processor and gaming code which is operable when executed on the processor to conduct a wagering game on which monetary value can be wagered; and
an audio module, the audio module operable to play an audio track, the audio track comprising a plurality of selected audio element tracks that are played at the same time to create the played audio track.

2. The computerized gaming system of claim 1, wherein each audio element track comprises one or more instruments not present in the other audio element tracks.

3. The computerized gaming system of claim 2, wherein at least one audio element track comprising one or more specific instruments comprises multiple phrases independently selectable for playback to create the played audio track.

4. The computerized gaming system of claim 3, wherein the multiple phrases are played back out of sequence to create the played audio track.

5. The computerized gaming system of claim 4, wherein the phrase sequence played back to create the played audio track comprises a randomly selected phrase order.

6. The computerized gaming system of claim 4, wherein the phrase sequence played back to create the played audio track is provided by an ordered list of phrases.

7. The computerized gaming system of claim 4, wherein the phrase sequence played back to create the played audio track comprises a phrase sequence selected based on priority weighting assigned to the phrases.

8. The computerized gaming system of claim 1, wherein two or more audio element tracks are randomly combined to create the played audio track.

9. The computerized gaming system of claim 1, wherein two or more audio element tracks are combined according to a predetermined list of audio element track combinations.

10. The computerized gaming system of claim 1, wherein two or more audio element tracks are selected and combined to produce the played audio track, the selection comprising evaluation of priority weighting of the various audio element tracks.

11. The computerized gaming system of claim 1, wherein the audio element tracks are played back repeatedly, and wherein the length of at least two of the audio element tracks are of different length.

12. The computerized gaming system of claim 1, wherein the played audio track further comprises a portion that is not a combination of audio element tracks.

13. The computerized gaming system of claim 1, wherein at least one of the plurality of audio element tracks is played using at least one randomized parameter, the parameters including at least one of volume, panning, reverb, equalization, compression, distortion, flange, and phase parameters.

14. The computerized gaming system of claim 3, wherein the audio element phrases are sorted into at least two subgroups.

15. The computerized gaming system of claim 14, wherein the audio elements in the phrase subgroups are grouped by compatibility with other audio element phrase groups.

16. The computerized gaming system of claim 1, wherein the audio element tracks are recorded using different sampling rates.

17. The computerized gaming system of claim 1, wherein at least one of the audio element tracks comprises music.

18. The computerized gaming system of claim 1, wherein at least one of the audio element tracks comprises sound effects.

19. A method of providing audio from a computerized gaming system, comprising:
playing an audio track, the audio track comprising a plurality of audio element tracks that are played at the same time by the computerized gaming system to create the played audio track, the computerized gaming system further operable to conduct a wagering game upon which monetary value can be wagered.

20. The method of claim 19, wherein each audio element track comprises one or more instruments not present in the other audio element tracks.

21. The method of claim 20, wherein at least one audio element track comprising one or more specific instruments comprises multiple phrases independently selectable for playback to create the played audio track.

22. The method of claim 21, wherein the multiple phrases are played back out of sequence to create the played audio track.

23. The method of claim 22, wherein the phrase sequence played back to create the played audio track comprises a randomly selected phrase order.

24. The method of claim 23, wherein the phrase sequence played back to create the played audio track is provided by an ordered list of phrases.

25. The method of claim 23, wherein the phrase sequence played back to create the played audio track comprises a phrase sequence selected based on priority weighting assigned to the phrases.

26. The method of claim 19, wherein two or more audio element tracks are randomly combined to create the played audio track.

27. The method of claim 19, wherein two or more audio element tracks are combined according to a predetermined list of audio element track combinations.

28. The method of claim 19, wherein two or more audio element tracks are selected and combined to produce the played audio track, the selection comprising evaluation of priority weighting of the various audio element tracks.

29. The method of claim 19, wherein the audio element tracks are played back repeatedly, and wherein the length of at least two of the audio element tracks are of different length.

30. The method of claim 19, wherein the played audio track further comprises a portion that is not a combination of audio element tracks.

31. The method of claim 19, wherein at least one of the plurality of audio element tracks is played using at least one randomized parameter, the parameters including at least one of volume, panning, reverb, equalization, compression, distortion, flange, and phase parameters.

32. The method of claim 22, wherein the audio element phrases are sorted into at least two subgroups.

33. The method of claim 32, wherein the audio elements in the phrase subgroups are grouped by compatibility with other audio element phrase groups.

34. The method of claim 19, wherein the audio element tracks are recorded using different sampling rates.

35. The method of claim 19, wherein at least one of the audio element tracks comprises music.

36. The method of claim 19, wherein at least one of the audio element tracks comprises sound effects.

37. A computerized gaming system, comprising:
a gaming module, comprising a processor and gaming code which is operable when executed on the processor to conduct a wagering game on which monetary value can be wagered; and
an audio module, the audio module comprising a plurality of audio element tracks, wherein selected audio element tracks are played at the same time to create a played audio track.
